(19) United States
(12) Patent Application Publication
(10) Pub. No.: US 2004/0056206 A1
(43) Pub. Date: Mar. 25, 2004

(54) Ionization chamber

(75) Inventors: Alexander I. Bolozdynya, St. Petersburg, FL (US); Aleksey E. Bolotnikov, Arcadia, CA (US); Stephen M. Schindler, Pasadena, CA (US)

Correspondence Address: LARSON AND LARSON, 11199 69TH STREET NORTH, LARGO, FL, 33773

(73) Assignee: CONSTELLATION TECHNOLOGY CORPORATION

(21) Appl. No.: 10/254,465

(22) Filed: Sep. 25, 2002

(51) Int. Cl. G01T 1/18

(52) U.S. Cl. 250/385.1; 250/374

(57) ABSTRACT

An ionization chamber is provided for the detection of nuclear radiation. The chamber is a vessel which acts as a cathode wherein at least one anode is disposed within the chamber and off-set from a center axis of the chamber. The chamber can be made from variety of shapes but is cylindrical in the preferred embodiment. The device contains two anodes in the preferred embodiment which are both off-set from the center axis. One anode collects the free floating electrons which are produced in response to particle ionization and therefore has a collected charge applied thereto. The second anode has the charge induced by immobile ions. The induced charge is subtracted from the collected charge thereby providing an improved resolution for the ionization chamber which translates into a more accurate result. In the preferred embodiment, a pressurized noble gas, such as xenon, is used. In some special geometries of the chamber, one of the anodes becomes part of the cathode and the charge induced by immobile ions becomes negligibly low. Thus the subtraction of the induced charge is not required.

### GOVERNMENT LICENSE RIGHTS

This invention was made with U.S. Government support under contract or grant DASG60-01-C-0078 awarded by U.S. Army Space and Missile Defense Command. The U.S. Government has certain rights in the invention.

### BACKGROUND OF THE INVENTION

1. Field of the Invention

This invention relates to an ionization chamber for detecting nuclear radiation. More particularly, it relates to an ionization chamber which employs at least two electrodes within the chamber wherein at least one electrode used as an anode is employed and off-set from a center axis of the chamber for providing a better energy resolution of the chamber.

2. Description of the Prior Art

Ionization chambers are well known in the art of nuclear physics. Ionization chambers employ a detector medium in a gaseous or condensed state. Examples of the gases used include low-pressure or compressed xenon (Xe), argon (Ar) and krypton (Kr) or combinations of these gases with organic admixtures. Condensed (liquid or solid) noble gases can also be used. Ionization chambers are primarily used for nuclear radiation detection, such as, for example gamma- or X-rays. Xenon is often used because of its high stopping power of gamma-rays. Uses for these detectors include, but are not limited to, safeguarding employees working around radioactive materials, preventing the removal of radioactive materials from secure locations by installing the device within a portal monitoring system, investigation of areas that have been exposed to radioactive materials, and detection of the proliferation of weapons of mass destruction (i.e., detection of weapon-grade Plutonium).

In its simplest form, an ionization chamber employs a cylindrical vessel, which acts as a cathode, and a single anode wire positioned along the center axis of the cylindrical chamber. Nuclear radiation, e.g. photon, interacts with the medium inside the ionization chamber and generates electron-ion pairs. An electrical field applied inside the chamber causes the electrons to drift towards the anode wire, where they are rapidly collected by the wire. In contrast, the ions whose mobility is very slow stay practically unmoved during the electron collection time. The induced charge inflicted upon the anode is electronically converted into the voltage signal, amplified, and its pulse-height is measured.

It can be shown that the pulse-height is directly proportional to the total number of the collected electrons minus the charge induced by the immobile ions. From the mathematical point of view, such treatment of the induced signal is equivalent to integrating of the current induced by the electrons while they drift toward the anode. If the trapping effect is neglected the collected charge is independent on the location of the point at which electron-ion pairs are initially created by the incident particle. In contrast, the charge induced by the immobile ions depends on the ions location inside the chamber. As a result, the height of the output signal becomes also dependable on the point of interaction of the incident particle. This effect, normally called the induction effect, degrades the energy resolution of any ionization chamber. As an example, the best energy resolution obtained with the simplest ionization chamber described above is about ˜4.5% FWHM at 662 keV. This is not considered to be a very good resolution.

Improvements to the simple ionization chamber, as described directly hereinabove, include a similar constructed chamber having a shielding grid surrounding the single anode. The grid is maintained as an intermediate electrode between the cathode and the anode and is kept under some potential required to provide 100% transmission of the electrons across of it. In this design, electric fields from the ions and electrons when they drift between cathode and grid are shielded by the grid and no signal is induced on the anode. Since each electron passes through the same potential difference and contributes equally to the signal pulse, the pulse-height is now independent on the position of formation of the original electron-ion pairs and is simply proportional to the total number of electron-ion pairs formed along the track of the incident particle. As a result, the energy resolution of the ionization chamber is improved. However, there are several drawbacks of this design. A charge-sensitive pre-amplifier, used to convert the induced charge into the output voltage signal, also sense the acoustic micro-vibrations of the grid (the so called “microphone effect”). This high-level noise directly contributes to the energy resolution of the chamber, and is proportional to the value of the grid-anode capacitance and to the grid bias. By optimizing the geometrical parameters of the grid, the energy resolution of the chamber can be enhanced. However, this requires higher expense due to the complexity of the design and the extra power supply requirements for the grid. Further, the grid is known to disturb the electrical field and provide for a less efficient resolution for the chamber. And, the volume surrounded by the grid can not be used for detection and is therefore wasted. Another manner in which to improve energy resolution of an ionization chamber is with the so-called coplanar grid technique, which was originally proposed for use in solid state detectors. In gas ionization chambers, a coplanar grid technique could be implemented with anode electrodes positioned on the surface of the cylindrical insulator replacing the shielding grid. However, direct copying of the design of small planar solid state detectors will cause difficulties in large size cylindrical ionization chambers, which are needed in many instances. Specific problems include: the anode capacitance becomes too large; high leakage current flaws occur between the coplanar electrodes on the insulator surface generating extra noise; an additional power supply is needed to bias the steering strips; and the electric field effect on the electron yield in the detector with the cylindrical geometry needs to be compensated to obtain good energy resolution.

An improved ionization chamber is needed. And in particular, an improved high pressure noble gas ionization chamber, using a substance such as Xenon, is needed to alleviate the problems encountered with the prior art detectors and to provide good energy resolution for the ionization chamber.

### SUMMARY OF THE INVENTION

We have invented an improved ionization chamber for use in detecting and precise measuring energy spectra of nuclear radiation which may be emanating from radioactive materials. Our novel design improves the energy resolution of the cylindrical ionization chamber without the need to use a shielding grid. In its simplest form, the novel device of the present invention employs a three electrode system, although nothing herein limits the number of electrodes to be used. The preferred embodiment of the present invention employs a highly pressurized noble gas, such as, xenon, as the substance filled within the chamber for efficiently absorbing the nuclear radiation.

Our improved chamber, in its preferred embodiment, employs two anode wires. The two anode wires are stretched along, but slightly off-set from the longitudinal (center) axis of the high pressure cylindrical vessel (chamber) which serves as the cathode. For the majority of the detected events, one of the two anode wires collects the electrons produced by the ionizing particles. As it was described previously, the amplitude of the induced signal, read out from this collecting wire, is proportional to the amount of the collected electrons minus the charge that is induced by immobile positive ions left in the point of interaction. The latter component of the total induced charge is the main cause of the poor resolution of the single anode wire configured cylindrical ionization chamber without the grid. In our improved chamber, the signals induced by the ions on both wires are nearly identical. The signal read out from the second wire, which does not collect the electrons, can be used to measure the component of the signal induced by the ions. Thus, the difference between the signals read out from the both wires is proportional to the total number of the original electrons only, i.e. to the total absorbed energy. It is also noted that the subtraction substantially reduces the “microphone effect”.

In an alternate embodiment, the two anodes are stretched along the vessel inner wall such that a first anode is positioned juxtaposed the vessel wall (the cathode) and the second anode is merged with the vessel wall to become part of the vessel wall (and therefore part of the cathode) having the same potential as the cathode. In this case, the charge induced by the ions becomes negligible and subtraction thereof from the collected electrons charge is not required. However, the effect is sensitive to a distribution of the electric field that requires optimization of the distribution for any particular design of the chamber and the anode.

In yet another alternate embodiment, the wire anodes are not stretched along the longitudinal axis of the vessel chamber but positioned at either end thereof. And, nothing herein limits the use of a non-cylindrical vessel chamber.

### BRIEF DESCRIPTION OF THE DRAWINGS

The invention can be best understood by those having ordinary skill in the art by reference to the following detailed description when considered in conjunction with the accompanying drawings in which:

FIG. 1 is an illustration of a prior art cylindrical ionization chamber having a cylindrical wall which acts as a cathode and a single anode located along a center axis of the cylindrical chamber;

FIG. 2A is a graphical representation of the total induced charge over time that the single anode of the prior art chamber illustrated in FIG. 1 would see as a result of the electron clouds initially produced in two different locations inside the chamber drifting towards the anode of FIG. 1 as shown therein;

FIG. 2B is a graphical representation of the distribution of the pulse-heights as seen in FIG. 2A wherein a resolution of ˜6% at FWHM is provided;

FIG. 3 is an illustration of another prior art cylindrical ionization chamber having a cylindrical wall which acts as a cathode, a single anode located along a center axis of the cylindrical chamber and a grid surrounding the single anode;

FIG. 4A is a graphical representation of the total induced charge over time that the single anode of the prior art chamber illustrated in FIG. 3 would see as a result of the electron clouds produced in two different locations inside the chamber drifting towards the anode surrounded by the grid of FIG. 3 as shown therein;

FIG. 4B is a graphical representation of the distribution of the pulse-heights as seen in FIG. 4A wherein a resolution of ˜2% at FWHM is provided;

FIG. 5 is an illustration of a preferred cylindrical ionization chamber of the present invention having a cylindrical wall which acts as a cathode and two anodes located proximal to a center axis of the cylindrical chamber, but offset;

FIG. 6 is a graphical representation of the total induced charge over time that the two single anodes of the chamber illustrated in FIG. 5 would see as a result of a single electron drifting towards anode1 and anode2 of FIG. 5 as shown therein;

FIG. 7 is an illustration of an alternate embodiment of the cylindrical ionization chamber of the present invention wherein it is illustrated how the two off-set anodes can be stretched along the chamber inner wall such that a first anode is positioned juxtaposed the chamber inner wall and a second anode merges with the chamber wall thereby becoming part of the cathode having the same electrical potential;

FIG. 8 is an illustration of the electrical field generated by the cylindrical ionization chamber shown in FIG. 7;

FIG. 9 is an illustration of the same embodiment of FIG. 7 wherein it is illustrated that only two electrodes are provided since the second anode has merged with the chamber inner wall and has thereby become part of the cathode having the same electrical potential; and

FIG. 10 is an illustration of the electrical field generated by the cylindrical ionization chamber shown in FIG. 9.

### DETAILED DESCRIPTION OF THE PREFERRED EMBODIMENT

Throughout the following detailed description, the same reference numerals refer to the same elements in all figures.

In determining the energy resolution of a cylindrical ionization chamber, the following mathematical formula can be is used:

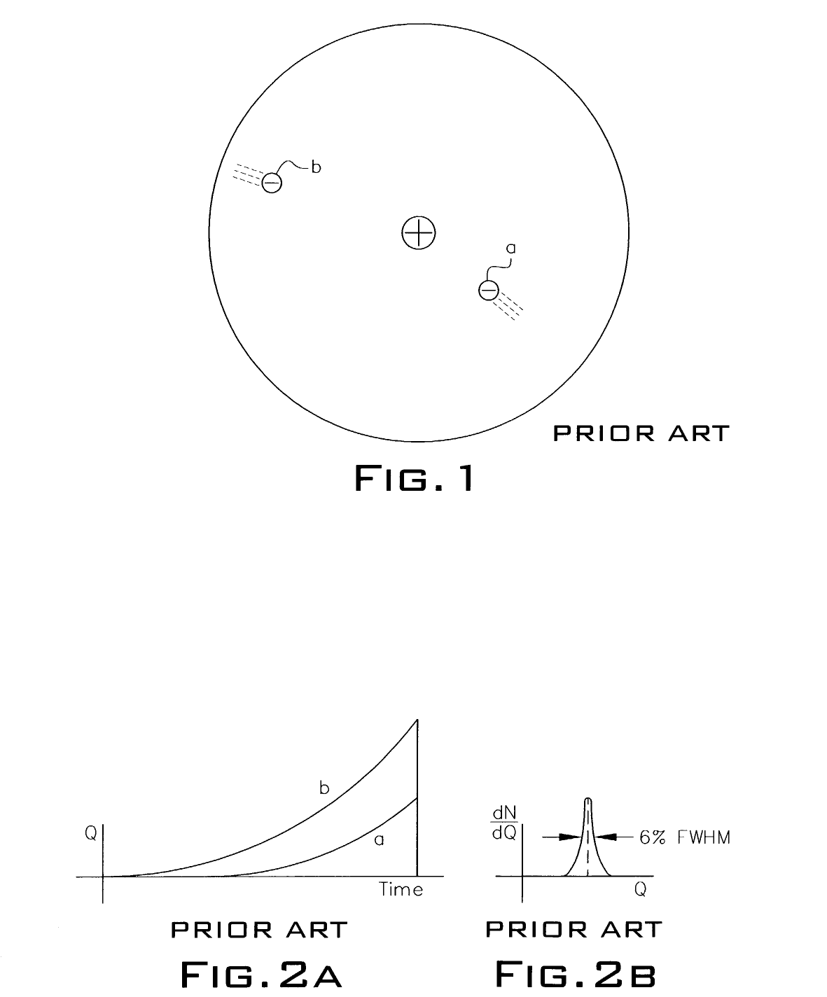

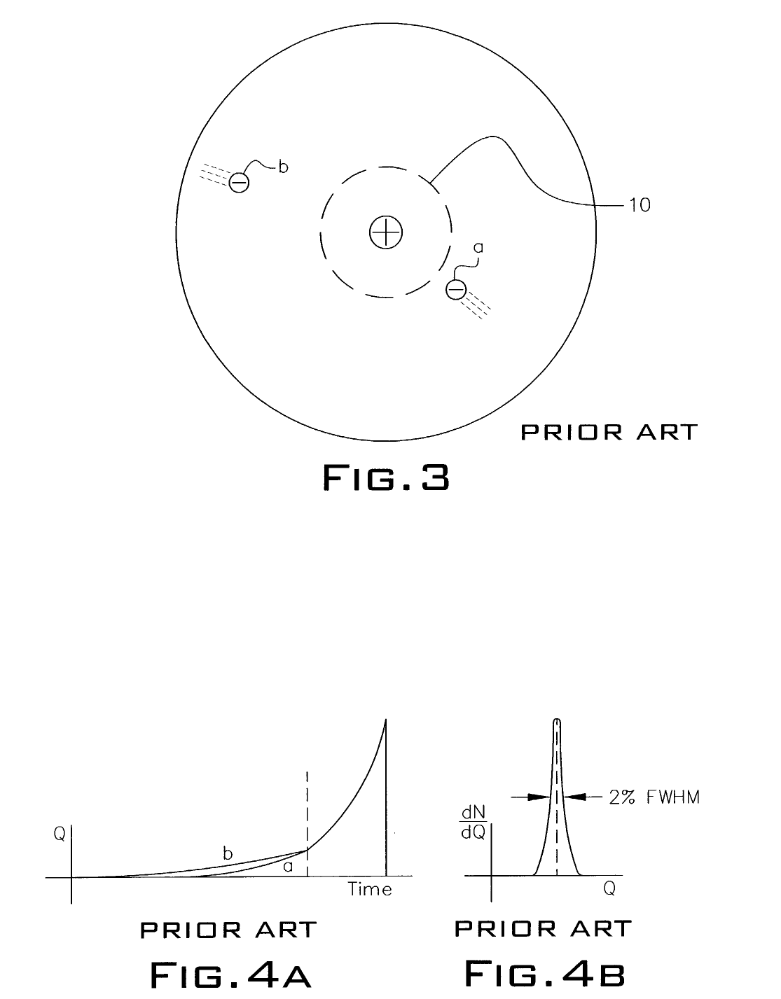

ΔE²=ΔE_{Xe}²+ΔE_{gw}+ΔE_{read}²

wherein, ΔE_{gw} is the geometrical width of the response function (i.e., distribution) of the cylindrical chamber and ΔE_{read} is the electronic noise of the read out system. In those prior art devices where no grid is used, ΔE_{read} can be quite significant (typically higher than 5%) which results in poor energy resolution for any two-electrode cylindrical chamber (i.e., the prior art device of FIG. 1). The noise can be reduced (sometimes reduced below 1%) by use of the grid 10, as shown in the prior art device of FIG. 3. However, to accomplish such results, it requires a higher cost factor and complex design features. Further, an extra power supply for the grid is required. And, as stated before, the grid is known to disturb the electrical field and provide for a less efficient resolution for the chamber. And even further, the volume between the grid and the anode can not be used for detection and is therefore wasted.

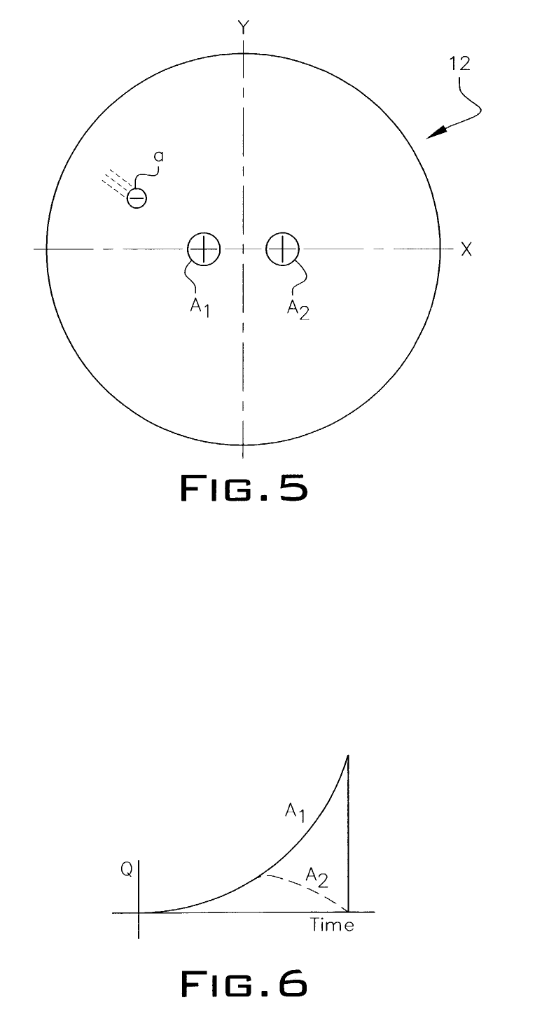

Referring to FIG. 5, a novel chamber 12 of the present invention is shown which eliminates the need for a grid. In chamber 12 of FIG. 5, two anode wires are employed, A₁ and A₂, respectively. Anodes A₁ and A₂ are stretched along a axis “X” and positioned proximal, but off-set, to a center axis represented by an intersection point of axis “X” and axis “Y” of a chamber 12. The high pressure vessel, or chamber 12, acts as a cathode. Accordingly, three electrodes are being employed. For most of the detected events, one of the two anodes, A₁ or A₂, will collect the electrons produced by the ionizing particles. This is accomplished by biasing one of the two anodes (such as A₂) with a slight negative potential thereby ensuring that all of the electrons will be collected by A₁. As shown in FIG. 5, a single electron “a” is designated. This is done merely for the purpose of illustration. It is of course understood that multiple electrons could be floating towards A₁ and A₂ at any given point. The amplitude of the signal, read out from A₁ is proportional to the amount of collected electrons minus the charge that is induced by low-mobile positive ions left in the point of interaction. As stated before, this induced charge is the main cause of the poor resolution of a single anode cylindrical chamber like that seen in FIGS. 1 and 2. In chamber 12, the induced signal can be subtracted by using the signal read out from A₂ (the two signals being illustrated in FIG. 6). Thus the difference between these two signals (that of A₁ and A₂) is proportional to the collected charge only, thereby resulting in superior energy resolution for chamber 12. The subtraction process alleviates the need to use the term ΔE_{gw} (geometric width of the chamber) in the formula. In addition, the microphone effect is significantly reduced.

Depending on the need of the application for chamber 12, wire anodes of different diameters could be employed as well different distances of separation for the two wire anodes and the varying diameters of the cathode (the vessel or chamber wall). For instance, used merely as an example, the cathode diameter could be 100 mm, each wire anode could be 0.4 mm while the separation between the two wire anodes could be 2 mm. Of course, an infinite number of combinations are available for use for the above set forth diameters and separation distances depending on the intended use of the chamber.

The use of chamber 12 results in extremely low electronic noise in the range of <1% with the intrinsic energy resolution of the high pressure Xe-filled detector at about ˜0.5% FWHM at 662 keV. This results in the total energy resolution of less than 2% FWHM at 662 keV—a very desirous result.

The electronic components used in chamber 12 include two DC-coupled charge-sensitive pre-amplifiers which are used to measure the induced signals from the two wire anodes. The signal subtraction is carried out by a simple circuit including two operational amplifiers. A gain adjustment allows for varying the relative gain of the two wire anode signals. The output signal is processed using standard spectrometric electronics to obtain pulse height distribution. The cathode bias is supplied by an adjustable HV power supply.

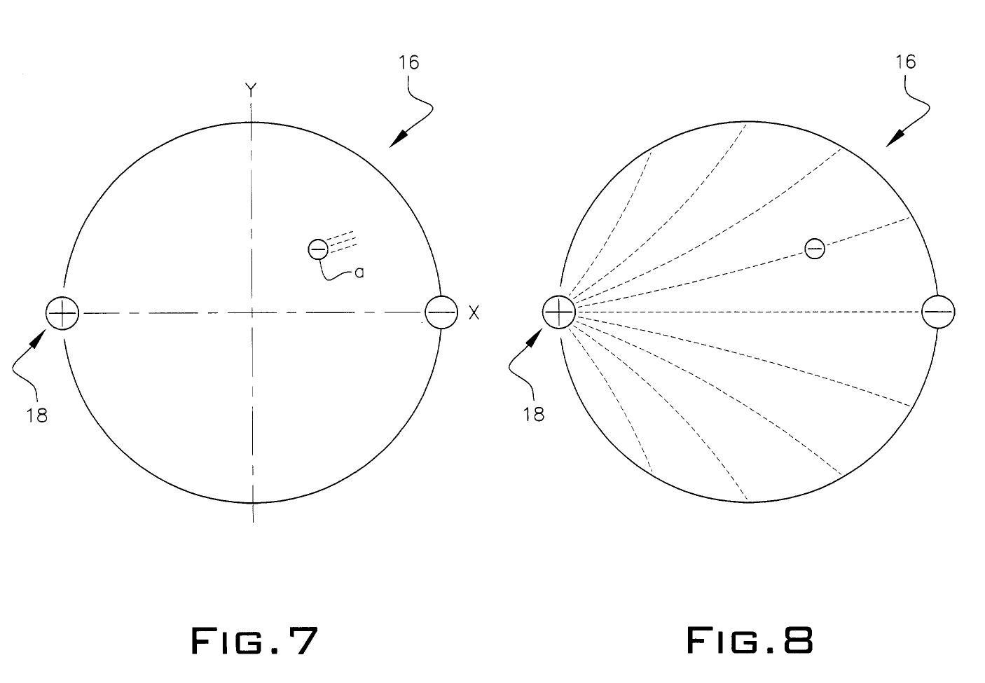

Referring to FIG. 7, an alternate chamber 16 is shown wherein the two anodes have been stretched along the inner side walls of the vessel chamber (cathode). The first anode 18 remains as a positive biased wire and is spaced from the wall of the vessel chamber as shown in FIG. 7. This of course means that anode 18 will collect any electrons floating within the chamber due to particle ionization. The second anode merges with the cathode wall and becomes part of the cathode and accordingly has the same negative potential as the vessel chamber (cathode). In this embodiment, no subtraction of an induced charge is required. FIG. 7 illustrates the second anode being integrally formed with the cathode wherein they are one in the same due to the merging thereof. FIG. 8 illustrates the electrical field generated by the ionization chamber shown in FIG. 7 wherein the two anodes have been stretched to the vessel chamber inner wall. In this embodiment, the induced charge on the anode would have a very fast rise time, as compared to that which is illustrated in FIG. 2A of the prior art device, wherein the rise time is very constant.

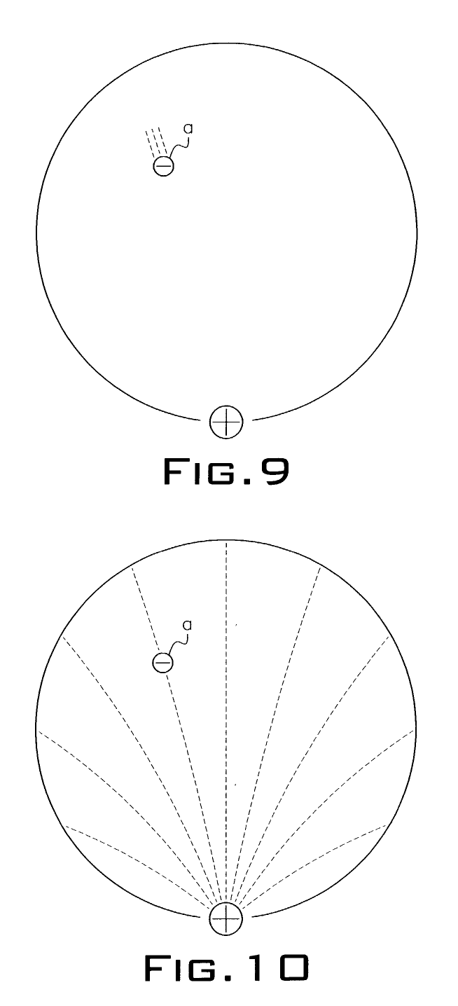

FIG. 9 represents the same embodiment of FIG. 7. However, it is illustrated that no second cathode is present. This is due, as discussed directly hereinabove, that the second anode merges with the cathode. Accordingly, this embodiment, and that of FIG. 7, can be said to be an ionization chamber having at least two electrodes wherein at least one anode is employed and is off-set from a center longitudinal axis. As stated before, a highly pressurized gas can be employed within the chamber, such as xenon. FIG. 10, as like FIG. 8, illustrates the electrical field generated by the ionization chamber shown in FIG. 9 wherein the two anodes have been stretched to the vessel chamber inner wall.

It is noted that the preferred embodiment of the present invention, and those illustrated herein as alternate embodiments, illustrate, and mostly describe, a cylindrical chamber for the vessel, which as discussed above acts as the cathode. However, nothing herein limits the use of other shaped chambers that are not cylindrical. Regardless of the shape of the chamber, the present invention would include at least two electrodes wherein at least one anode would be employed which would be off-set from a center longitudinal axis. It is understood that the term “off-set” means that the at least one anode is spaced apart from the center longitudinal axis as best illustrated in FIGS. 5 and 7 through 10. It is further noted that the anode or anodes do not have to be wires or strips. Other shaped anodes, such as pads, depending on the shape of the chamber, can be employed.

In all of the figures relevant to the present invention, and not the prior art, the anodes are illustrated as having a positive potential. This is to say that the anode or anodes are positively biased in relation to the cathode. However, the anode or anodes may be on the ground potential.

It is further understood that equivalent elements can be substituted for the ones set forth above to obtain substantially the same result in the same manner thereby performing the same function.

Having thus described the invention, what is claimed and desired to be secured by Letters Patent is:

1. An ionization chamber for detecting nuclear radiation comprising:
a) an enclosed vessel having a longitudinal center axis, an inner wall and an internal chamber;
b) at least two electrodes including a cathode and at least one anode, the cathode integrally formed with the vessel inner wall and the at least one anode off-set from the vessel longitudinal center axis, the at least one anode collecting free floating electrons within the chamber in response to particle ionization, the at least one anode having a collected charge applied thereto which is used to measure a resolution of the chamber; and
c) the vessel internal chamber filled with a substance that absorbs nuclear radiation.

2. The ionization chamber of claim 1, wherein the enclosed vessel is cylindrically shaped.

3. The ionization chamber of claim 1, wherein the substance that absorbs nuclear radiation is a noble gas.

4. The ionization chamber of claim 3, wherein the noble gas is xenon.

5. The ionization chamber of claim 1, wherein the at least one anode off-set from the vessel longitudinal center axis is a wire stretched proximal to the longitudinal center axis.

6. The ionization chamber of claim 1, wherein the at least one anode off-set from the vessel longitudinal center axis is a wire stretched juxtaposed to the vessel inner wall separated by a small gap.

7. The ionization chamber of claim 1, wherein the at least one anode is a pad mounted on an end section of the enclosed vessel.

8. The ionization chamber of claim 1, wherein three electrodes are employed including the cathode and first and second anodes off-set from the vessel longitudinal center axis.

9. The ionization chamber of claim 8, wherein the first anode collects all of the free floating electrons and the second anode has a charge induced by immobile ions.

10. The ionization chamber of claim 9, wherein the amplitude of the output signal of the chamber is determined by subtracting an induced charge of the second anode from an induced charge of the first anode.

11. An ionization chamber for detecting nuclear radiation comprising:
a) an enclosed vessel having a longitudinal center axis, an inner wall and an internal chamber;
b) at least three electrodes including a cathode and a first and second anode, the cathode integrally formed with the vessel inner wall and the first and second anodes off-set from the vessel longitudinal center axis, the first anode having a collected charge applied thereto and the second anode having a charge induced by immobile ions applied thereto; and
c) the vessel internal chamber filled with a substance that absorbs nuclear radiation.

12. The ionization chamber of claim 11, wherein a resolution of the chamber is determined by subtracting the induced charge of the second anode from the collected charge of the first anode.

13. The ionization chamber of claim 11, wherein the enclosed vessel is cylindrically shaped.

14. The ionization chamber of claim 11, wherein the first and second anodes off-set from the vessel longitudinal center axis are individual wires stretched proximal to the longitudinal center axis.

15. The ionization chamber of claim 11, wherein the first anode off-set from the vessel longitudinal center axis is a wire stretched juxtaposed to the vessel inner wall separated by a small gap and the second anode off-set from the vessel longitudinal center axis is integrally formed with the vessel inner wall.

16. The ionization chamber of claim 11, wherein the first anode off-set from the vessel longitudinal center axis is a pad positioned on an end portion of the enclosed vessel and the second anode off-set from the vessel longitudinal center axis is integrally formed with the vessel inner wall.

17. The ionization chamber of claim 11, wherein the substance that absorbs nuclear radiation is a noble gas.

18. The ionization chamber of claim 17, wherein the noble gas is xenon.

19. A high pressure xenon filled ionization chamber for detecting nuclear radiation comprising:
a) an enclosed cylindrical vessel having a longitudinal center axis, an inner wall and an internal chamber; and
b) at least three electrodes including a cathode and a first and second anode, the cathode integrally formed with the vessel inner wall and the first and second anodes off-set from the vessel longitudinal center axis, the first and second anodes including wires longitudinally stretched proximal to the vessel longitudinal center axis, the first anode having a collected charge applied thereto and the second anode having the charge induced by immobile ions applied thereto.

20. The ionization chamber of claim 19, wherein the amplitude of the output signal of the chamber is determined by subtracting the induced charge of the second anode from the collected charge of the first anode.
